(19) United States
(12) Patent Application Publication
(10) Pub. No.: US 2014/0143080 A1
(43) Pub. Date: May 22, 2014

(54) AUCTION QUERY AND NOTIFICATION SYSTEM

(71) Applicant: Keith N. Kelman, La Jolla, CA (US)

(72) Inventor: Keith N. Kelman, La Jolla, CA (US)

(21) Appl. No.: 13/862,406

(22) Filed: Apr. 13, 2013

Related U.S. Application Data
(60) Provisional application No. 61/624,246, filed on Apr. 13, 2012.
(60) Provisional application No. 61/804,119, filed on Mar. 21, 2013.

(51) Int. Cl. G06Q 30/08

(52) U.S. Cl. CPC G06Q 30/08
USPC 705/26.3

(57) ABSTRACT

An Internet-based, multi-user-adaptable system for connecting auction agencies to interested customers and providing users notifications of upcoming auctions. The auction query and notification system compiles data from auction agencies and compares that information to user preferences, notifying individual users in a specified manner of upcoming auctions. The system further provides the ability to both connect auction agencies to a wider customer base and notify customers of upcoming auctions regarding their desired subject matter in a preferred area via email, text, or instant message.

### RELATED APPLICATIONS

This application claims the benefit of priority to United States Provisional Patent Application for “Auction Query and Notification System,” Ser. No. 61/624,248, filed on Apr. 13, 2012, and United States Provisional Patent Application for “Auction Query and Notification System,” Ser. No. 61/804,119 filed on Mar. 21, 2013, and currently copending.

### FIELD OF THE INVENTION

The present invention relates generally to art and other auctions and auction notifications and reminders. The present invention is more particularly, though not exclusively, directed to an Internet-based, multi-user-adaptable system for connecting auction agencies to interested customers and providing notifications of upcoming auctions. The present invention provides the ability to both connect auction agencies to a wider customer base and notify customers of upcoming auctions regarding their desired subject matter in a preferred geographic area via email, text, by instant message or by application (“app”) alert.

### BACKGROUND OF THE INVENTION

For many years, the world of auctions has been more or less dominated by a few world-renowned names, such as Christie's and Sotheby's, among other houses that have been in operation since the 18th century. Though perhaps not as big, or as successful, there are hundreds of other auction agencies in the United States and overseas that conduct art auctions periodically for art, antiques, collectibles, and other items of interest.

Auction agencies make a commission on each product successfully sold at auction, and often from both the buyer and the seller. These commissions, often known as the “buyer's or seller's premium,” are typically appended to the sale, or “hammer” price of the lot sold. In fine art the buyer's premium might be as high as 10%-30%, and accordingly, the higher the hammer price, the more profit generated for the auction agencies. Auction sale prices may increase when the number of interested buyers increase who may have an interest in acquiring a particular item and are aware that the item is going to be offered at auction. Generally speaking then, the more people that participate in an auction for a particular item, the higher the competition for that item becomes, which may result in an increase in the hammer price. Thus, it is to the organization's benefit to have a large audience. But in order to participate as a bidder in an auction a customer must first know about it. One way to ensure a large audience is careful and effective advertising. The Internet is one place where all auction agencies have at least a small footprint.

Auction listings on the Internet are spread between individual auction agency webpages, and a few aggregators, whose listings are periodically updated as events come and go, and as inventories are sold. While most of these listings are Internet-based and available by way of a mouse click, there are countless different listings, and often are not separated or categorized by category, genre, style, period, or medium. Further, an individual in search of a particular piece of art or other items of interest that may only appear on the auction block once every several years may be so elusive as to slip by unbeknownst to the individual seeking it, unless he or she is truly diligent in remaining abreast of the many auction inventories. This process is exceptionally time consuming.

In order for an individual to keep pace with upcoming auction schedules, schedule changes, and the auction sale of particular pieces of art, the avid art enthusiast must spend countless hours combing these hundreds of auction listings for interesting pieces of art. No currently existing system is capable of automatically aggregating auction schedules, tracking the ensuing auctions and items of interest, and subsequently notifying customers of their occurrence.

In light of the above, it would be advantageous to provide an Internet-based art auction information aggregation system that queries online auction agency databases, receives information regarding auction inventories for art and all other items of interest, auction schedules, and providing an information clearinghouse for individual customers. It would be further advantageous to match user search criteria with auction entries in the databases, at which point user-directed messages can be sent via email, text, instant message, or App alert, notifying the user that an event matching their preferences has been scheduled or is pending. Among other notification features, it would be advantageous to provide a website link which could make available detailed information such as telephone number and street address. Users may be notified of upcoming auctions for specific items, based on stored user preferences. This would alleviate much of the effort associated with seeking out individual auction agency information while simultaneously broadening the customer base of the auction agencies involved.

### SUMMARY OF THE INVENTION

The system contemplated by the present invention is an auction query and notification system, connecting auction customers to current auction inventory, listings, websites, and schedules, notifying them by email, text, instant message, or app of upcoming auctions for specific items. The system of the present invention first “queries” the Internet and individual auction houses for information regarding auction inventories and schedules, then “notifies” and “links” the interested individual member(s) of upcoming sales according to their specific user preferences.

Auction agencies may upload their inventory and auction schedules to the query and notification system. The system is also capable of polling various Internet sites, gathering information about upcoming events, particularly, but not solely, art auctions, in addition to the inventory of particular items up for auction. Individual auction agencies may expressly furnish this information to the query and notification system, or the information may be acquired from other sites that publicly offer such information on the Internet or from auction websites, publications, or other available sources. All of the auction data is sorted and categorized within the system database, which then is utilized as an auction information clearinghouse for members.

Members create user accounts, providing select personal information, including contact preferences such as phone numbers, email addresses, instant message (IM) handles, and proprietary apps. Contact information and notification preferences for each user are stored in a “user notification profile.” User accounts also contain records of each member's auction preferences with such categories as medium, genre, period, and artist, among others, and these are stored within “user interest profiles.” The categories each user selects are recorded within their user interest profiles on the system and continuously compared to the auction database. Once the member has created a user account, he or she may browse listings using search commands, or take advantage of the notification services provided by the system.

The query and notification system then compares the user database with the auction database, generating matches where data entries correspond to the information in the user interest profile. These matches may be displayed or then transmitted as an alert or reminder via means specified in the user notification profile to the member, notifying the member of upcoming auctions, schedule changes, and auction sales of particular pieces of art, collectibles, or other desired items. Additionally, the notification alert may include electronic links to the auction house websites. Prospective bidders could then contact the auction house from their computer, smart phone, or telephone in order to retrieve additional information including directions to the auction house, sale time, condition report, provenance, pedigree or even set up a telephone/online bid.

### BRIEF DESCRIPTION OF THE DRAWING

The nature, objects, and advantages of the auction query and notification system of the present invention will become more apparent to those skilled in the art after considering the following detailed description in connection with the accompanying drawings, in which like reference numerals designate like parts throughout, and wherein:

FIG. 1 is a schematic block diagram of the auction query and notification system of the present invention, depicting the overall system architecture and interrelation of multiple auction agencies, the information paths between the auction agencies, the Internet, and the system databases, in addition to the interaction of multiple users with the system through personal computers and smartphones, via the Internet and cellular service providers;

FIG. 2 is a flow chart depicting the process by which the query and notification system of the present invention accesses, sorts, and assimilates auction agency inventory and schedule information into the system database and then compares the data to the user preference database, displaying the matches, and generating user-specific notifications, and sending alerts and reminders to users;

FIG. 3 is a flow chart depicting the process by which the query and notification system of the present invention accepts new member account input, user preferences as to auction interest criteria, and alert and reminder preferences;

FIG. 4 is an example of a user account information input page, showing blocks for input of user-specific contact information, notification and reminder preferences, and auction preferences with specific categories for medium, genre, period, and artist, among other specific criteria; and

FIG. 5 is an example of the notification preferences input page which, in addition to FIG. 4, includes alert preferences with specific categories for pertinent information regarding the relevant auction house including contact information and website link.

### DETAILED DESCRIPTION OF A PREFERRED EMBODIMENT

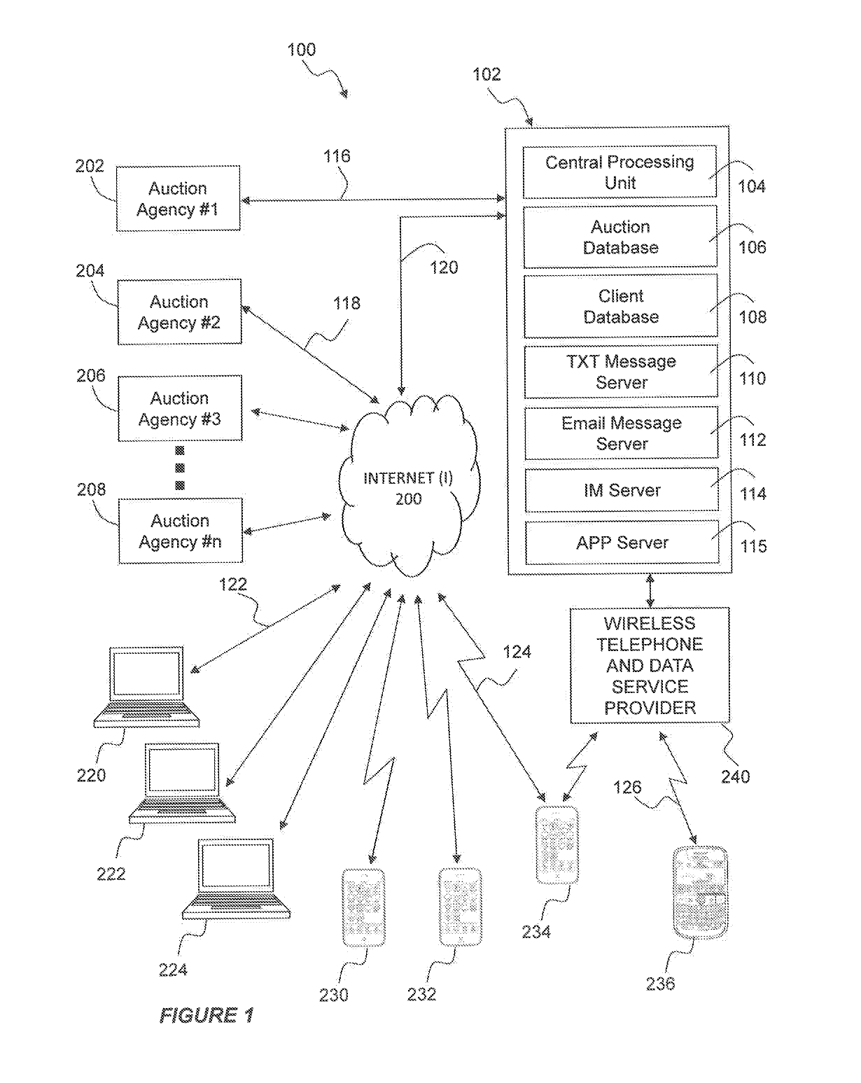

Referring initially to FIG. 1, the overall system architecture of the Auction Query and Notification System of the present invention is shown and generally designated 100. System 100 includes server 102; Auction Agencies, 202, 204, 206, and 208; personal computers 220, 222, and 224; and smartphones 230, 232, 234, and 236, all interconnected through Internet 200 or other means known in the art.

Server 102 is the Auction Query and Notification server, composed of a central processing unit (CPU) 104, Auction Database (DB) 106, Client DB 108, Text (TXT) Message Server 110, Email Message Server 112, Instant Message (IM) Server 114, and an application (“App”) server 115. Server 102 is connected through various outputs to the Internet 200.

CPU 104 provides the operating system for the various subsystems and software applications contained within it or configured to interface with the system. Auction DB 106 receives, sorts, and stores incoming auction information from an information path, such as Internet 200, and maintains a categorized and fully searchable database of the incoming data from various inputs. Client DB 108 provides a storage location for all user account information and provides an efficient means for comparing user interest profiles with the auction DB 106 and generating matches and notifications predicated on user notification preferences.

Once the notifications have been generated by CPU 104, a user may browse the matches on the user's personal computer 220 or smart phone 230. Additionally the matches are provided to the TXT message server 110, email message server 112, IM server 114, and App server 115 to generate and send notifications to the user in the specified form in accordance with user notification profiles.

Connections, also referred to as information paths, between the server 102 and auction agency 202 may be a direct mechanical connection 116, in which auction agency 202 provides auction information directly to the server 102. In this sense, a “mechanical” connection 116 is not through the Internet. Information transmitted to server 102 via this mechanical connection 116 may be delivered via standard mail, in the form of paper files, a CD ROM, or even a flash drive, containing pertinent art auction or other auction information. In light of the Internet, mechanical connection 116 is not the most expeditious method; however those auction agencies 202 that distribute information in such a manner may prefer such a delivery method. Additionally, since much of the available auction information is disseminated via electronic mail and traditional publications (magazines, newspapers, etc.), the data may be input directly to server 102 by system administrators.

In a preferred embodiment, auction agency 204 is connected to the Internet via Internet connection 118 and provides auction information to server 102 directly over connection 120, through a file transfer protocol (FTP), an emailed file for a database update, or another periodic or streaming update method. An arrangement such as this may be accomplished by contract or by license with auction agency 204, but such a direct arrangement with server 102 is intended to alleviate the need to poll or crawl individual auction agency 206, 208 websites for publicly available information. It is to be appreciated by those skilled in the art that there are an abundance of different methods to transfer such information known in the art, and examples provided herein are not intended to be limiting.

In an embodiment, auction agency #3 206 through auction agency #n 208 are representative of the innumerable auction websites available via the Internet. Each of these websites is available to server 102 through Internet connection 120. Server 102 is further capable of crawling all of the websites of auction agency #3 206 to auction agency #n 208, gathering pertinent auction information sorting the data, and storing the data in auction DB 106. That is, there is virtually no limit to the number of auction house websites 206, 208 that server 102 may query. The only limitation is the time it takes server 102 to query the desired auction house 208 website(s). It is to be appreciated by those skilled in the art, that limitations imposed on such a website query process are rooted in the hardware and software configurations of server 102, and the availability of auction information provided via Internet connections 118 and retrieved by server 102 via Internet connection 120.

All of the auction information, whether gathered via mechanical connection 116, directly furnished by auction agency 204, or captured from auction agencies 206, 208 public websites, is sorted and stored within auction DB 106. The sorted and stored auction information is then easily searchable by CPU 104 facilitating later comparison to client DB 108.

In a preferred embodiment, individuals utilize personal computers 220, 222, and 224 through Internet connections 122 to access their personal user accounts within system 100, and more particularly server 102. It is to be appreciated by those skilled in the art that the number of personal computers shown in this Figure is exemplary and not intended to be limiting.

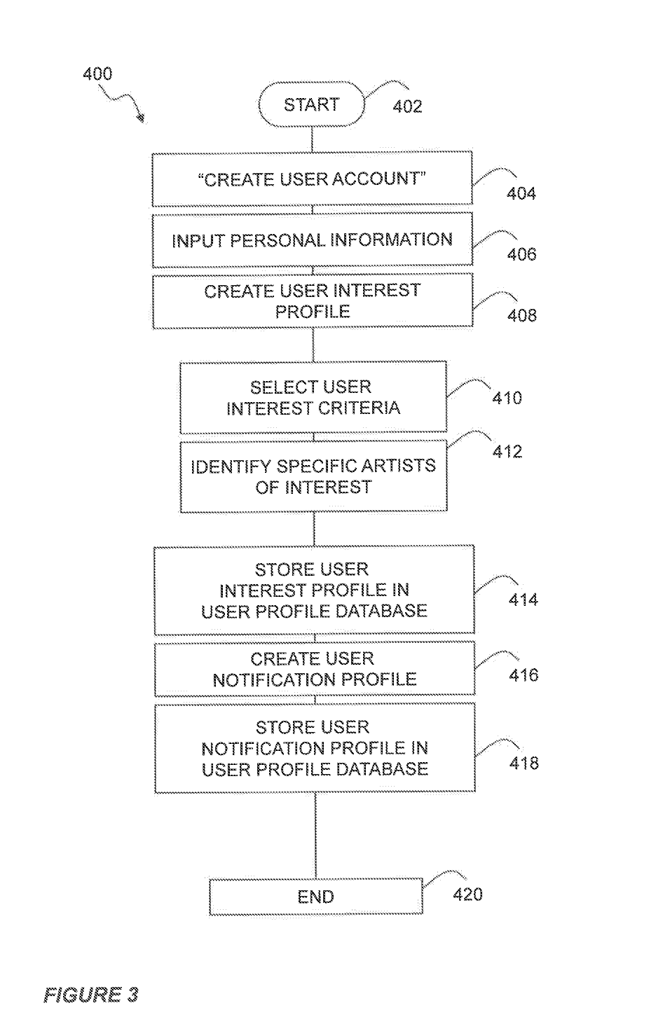

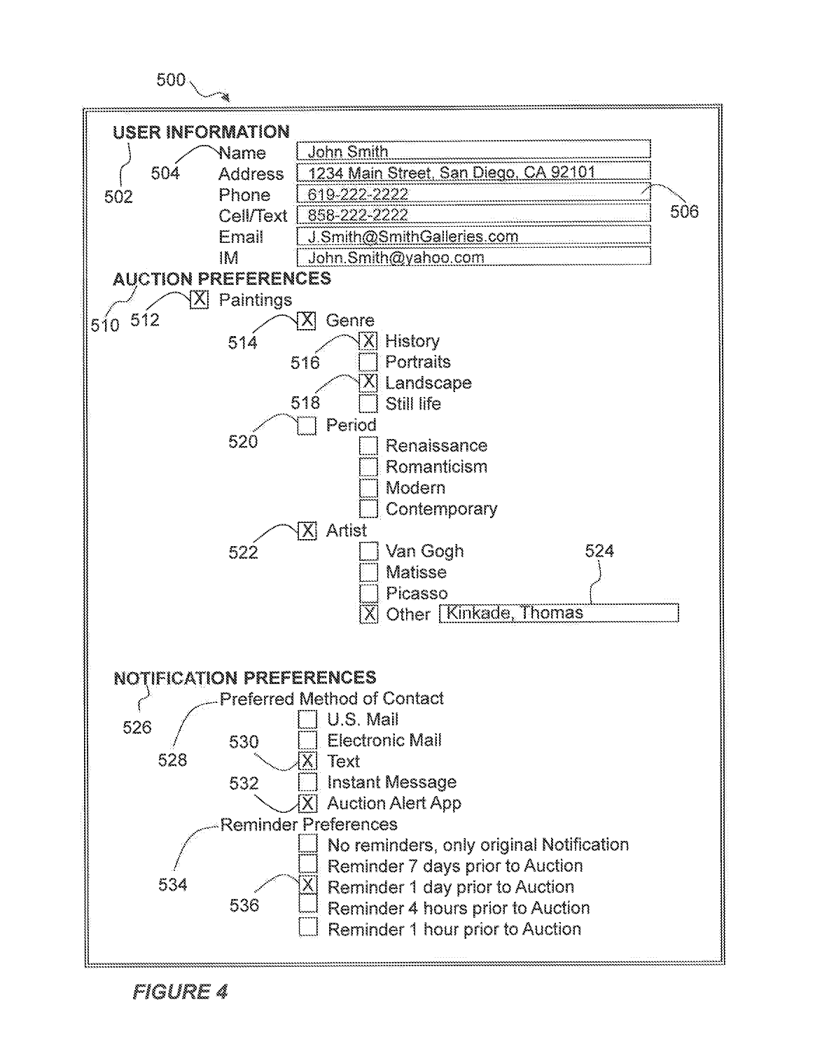

When a user creates an account (described below in conjunction with FIGS. 3 and 4) his or her information is stored within client DB 108. The personal information stored will include contact information, such as telephone numbers, email addresses, IM handles, and mailing addresses stored in the user notification profile, in addition to the user interest profile which includes preferences corresponding to the specific art, or other items of interest, a particular user seeks. Also, the personal information may include periodic payment information for the users' access to the system 100 of the present invention.

In an exemplary embodiment, an individual using personal computer 220 is a fine art collector in search of auctions for oil paintings of several different American artists or schools. When the user at personal computer 220 inputs his information, he will provide not only his preferred contact means in the user notification profile, but also specify that he seeks particular artists', or art schools' paintings. This user-specific information is transmitted to the server 102, and stored in client DB 108.

In a preferred embodiment, data within Client DB 108 are continually compared to data within auction DB 106. When an auction for an oil painting by a particular artist, for instance, is placed in the inventory at auction agency 204 within the Internet reach of server 102, that data entry will appear in auction DB 106. As the CPU 104 conducts the appropriate comparison protocols between client DB 108 and auction DB 106, a match will appear. The user at personal computer 220 in search of particular artists' paintings up for auction at auction agency 204 will then receive a notification or reminder linking the user to desired information according to the user notification preferences he selected.

Similar to personal computer 220, personal computers 222, 224 can be used to create additional user accounts, providing search criteria and personal contact information for the users. When matches are found for associated users at those computers for example, personal computer 222 may receive an email alerting the user, or personal computer 224 may receive an instant message with similar auction information. It is to be appreciated by those skilled in the art that each user account may be configured to receive multiple notifications, or none as desired. This is explained in more detail below.

In an embodiment, smartphones 230, 232, 234, and 236 are further utilized to take advantage of services provided by server 102. Similar to personal computers 220, 222, 224, smartphones 230, 232, 234, 236 are capable of creating user accounts, manipulating associated personal information and desired auction information. Smartphones 230, 232, as shown, are connected to server 102 via Internet connection 124 by which the user receives his or her alerts for upcoming auctions. Internet connection 124 may be a Wi-Fi (wireless Internet) or similar. Smartphones 234, 236 take advantage of the same functions through their wireless telephone and data service provider 240 via wireless connection 126. Wireless connection 126 is envisioned as a standard cellular or wireless service such as GSM, 4G LTE, or other industry standard. In an embodiment, smartphone 234 utilizes both wireless connection 126 and Internet connection 124, and have full access to individual user accounts.

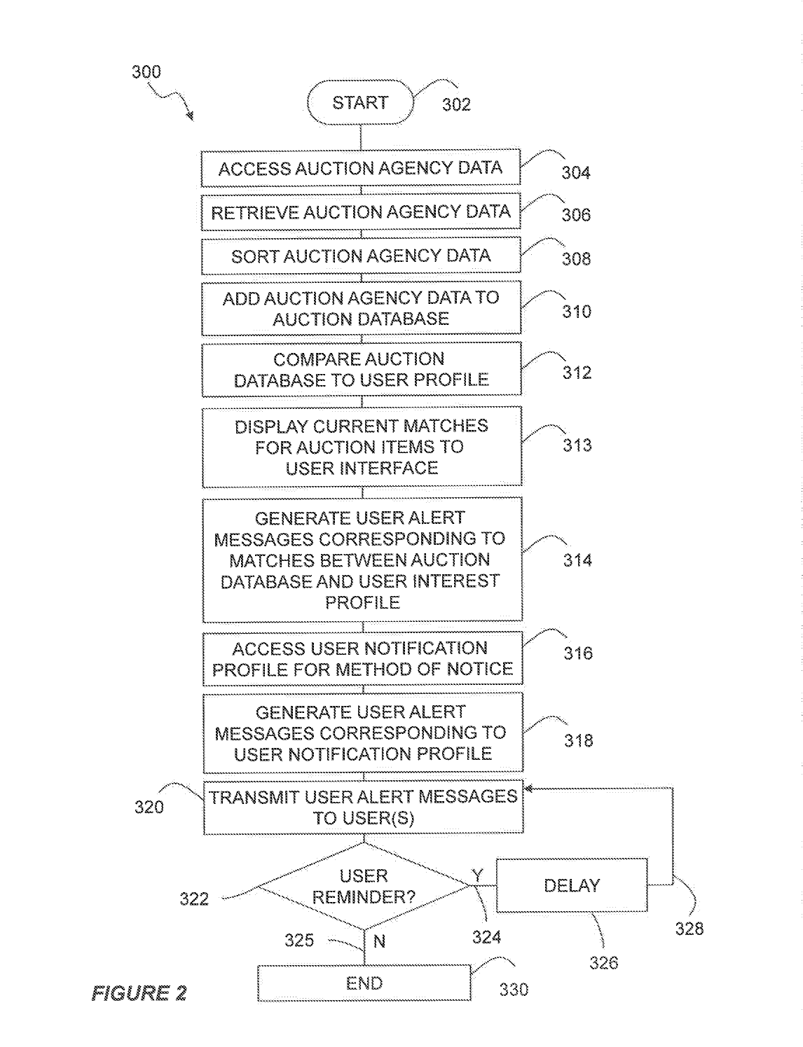

Referring now to FIG. 2, a block diagram of the message generation process is shown and generally designated 300. The auction query and notification system 100 begins the process at the start cue 302 and conducts separate processes at each step. From the start cue 302, CPU 104, via Internet connection 120, executes step 304 and accesses auction agency data and retrieves auction agency data at step 306. As stated above, there are multiple sources of auction data, and step 306 is completed by receipt of information from auction agency 202 via mechanical connection 116, directly from auction agency 204 via Internet 200, or by crawling individual websites of auction agencies 206, 208, as explained above. Because different auction agencies 202, 204, 206, and 208 may utilize different formats, information, or language in their product, event, and status listings, among other information, an embodiment of step 306 of the message generation process 100 also translates incoming data to an appropriate format to allow easy translation to any required display type.

In step 308, auction agency data is sorted based on various criteria, such as period, genre, and artist, colors, artist schools, medium types (oil, water color, drawings, etc.), among various other categories. Suitable criteria would be included if searching auctions for pottery, antiques, coins, etc.

These categories can be modified through action of administrators of system 100, based on input from users or requirements of the system 100. Once the auction data are sorted, the data are added to the auction DB 106 in step 310, where the database is fully searchable by both CPU 104 and users on personal computers 220, 222, 224 or smartphones 230, 232, 234, 236.

The data in auction DB 106 is compared to the user interest profile data in client DB 108. This step 312 determines matches between auction DB 106 and user profiles. The matches may be displayed to the user in step 313. Matches generated in step 312 lead to alert message generation in step 314 based on the user interest profiles. User notification profiles, also stored in client DB 108, are accessed in step 316 in order to determine the precise method of notification desired by the individual user. In step 318, the alert messages from step 316 are converted to text messages, emails, instant messages, or app alerts, including pertinent auction alert information with contact information and website links. Messages are transmitted from the appropriate TXT message server 110, email message server 112, IM server 114, or App server 115 in step 320. Computer applications are also contemplated herein, and are intended to include but not be limited to the application specific software that is available for downloading to smart phones and portable electronic devices, and allow notifications from the present invention to be retrieved from system 102 and presented to the user.

Following the transmission of user alert messages in step 320, process 300 proceeds to logic gate 322, which determines whether the user notification profile requires a reminder for the alert. If the result is a YES 324, then the system will delay in step 326 for a period of time determined by the user notification profile, and loop 328 back to step 320 providing the alerts desired by the user notification profile. This process is repeated until the number of alerts set in the user notification profile is exhausted. If logic gate 322 results in a NO 325, then no reminders are sent to the user, and process 300 proceeds concludes at step 330.

Referring now to FIG. 3, an exemplary profile creation process 400 is shown as a block diagram. Profile creation process 400 begins at step 402 as the user accesses the auction server 102 website. In step 404, if the user does not already have an account or a user profile, he will select an option allowing him or her to create a new user profile. Step 406 will require the user to input personal information, such as providing his or her name, address, and contact information, including telephone number, email address, IM handles, and payment information, as applicable. In an embodiment, select demographic information is also requested.

In step 408, the user begins the process of creating the user interest profile. This profile consists of preferences concerning the type of auction in which the user is interested. Sub-step 410 requests input of preferences including the genre of art (such as sculpture or paint), the period of the art (such as classical or postmodern), genre (such as impressionist or realist). The foregoing list of criteria is not intended to be limiting, as there are many further criteria that might be employed such as size, colors, medium, date of creation, among many others. Sub-step 412 further requests input of specific artists or countries of origin. Here again, it is to be appreciated by those skilled in the art there are many other preference options applicable here as well, including but not limited to other collectibles and are not limited to art.

All of this user-selected information is then compiled and stored as a user interest profile within the client DB 108 in step 414.

Once the user interest profile is complete, the user will proceed to step 416 where the notification preference profile is created. Step 416 requires the user to select among the various personal communication options input in step 406. If email, telephone number, and IM handle are all input in step 406, then the user may prioritize the communication platforms through which he or she desires to receive notifications. This is useful if the user only wishes to receive notifications through one means or another. Conversely, if the user desires to be notified through all available means, that too is an option, selectable in step 416. Also in step 416, alert preferences are selected to indicate the types of pertinent information and links the user desires to be included in the notification reminders. The user notification preferences are then stored within client DB 108 in step 418. Once all the information has been uploaded, the user profile creation process 400 ends at step 420, and the profile becomes an active entity.

Referring now to FIG. 4, an exemplary profile input form is depicted and generally designated 500. Profile input form 500 includes specific user information 502, auction preferences 510 and notification preferences 526. Specifically, user information section 502 includes inputs for user name, address, phone number, options for wireless phone number or text service, and email, credit card, or bank account information to be added in data fields 506. It is to be appreciated that this list of personal information is not exhaustive, as there may be further options available to a particular customer. This user information is input during account creation and it is intended that all of the information is freely editable by the account owner, as required. Further, an embodiment contains spaces for optional input of demographic information.

Section 510 of the exemplary profile input form 500 in FIG. 4 includes the user's auction preferences, includes a selection box 512 identifying “paintings.” This is an exemplary embodiment of the profile input form 500 contains multiple selection boxes with associated preference options, in categories and subcategories, such as genre 514, period 520 and artist 522, as shown. In this example, the user is interested in auctions for works of art in paint, however this could easily be a listing for sculpture, charcoal drawings, etc. Once the medium (paint, in this instance) is selected, the user may select from amongst other such criteria as genre, period, and artist by selecting, or marking, the desired criteria. Further specific options are automatically populated by the system based on the category selected. Thus genres, periods, and artists specific only to painting will populate the lower part of the form in this instance, allowing more precise selection by the user. Other categories might also be employed, such as style, country of origin, or even creation date.

It is also to be appreciated while profile input form 500 includes only a listing 512 for paintings, other types of items of interest may be included. For instance, other types of artwork, including sculpture, pottery, carvings, castings, tapestries, and embroidery may be identified and are consistent with the present invention. Indeed, the system 100 of the present invention may be used to facilitate the dissemination of information and notifications pertaining to auctions of anything.

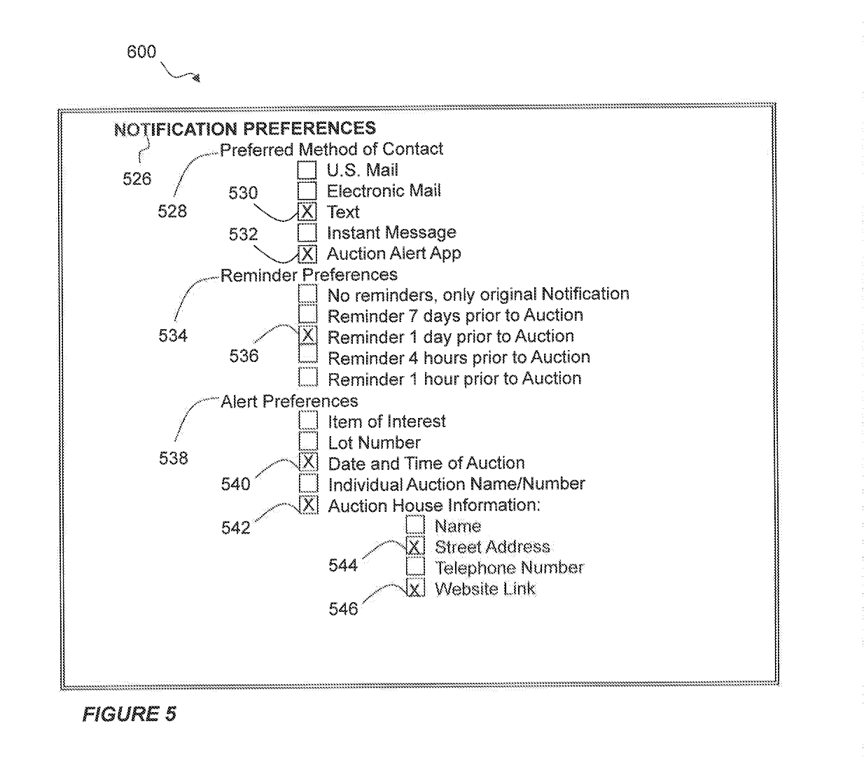

Notification preferences 526 include a preferred method of contact section 528 which automatically populate based on the personal information input in spaces throughout the input form 500. In the present example, U.S. Mail, electronic mail, text, instant messages, and auction App alerts are presented and available as means for transmitting notifications to the user. Here, the user has selected text 530 and auction app alert 532 as his or her preferred method of contact. In an alternative embodiment, there are further options for facsimile, apps, and other user interfaces, including website links and contact information as shown in FIG. 5 below.

Once the preferred methods of contact are selected, the user may choose specific reminders preferences 534 for individual notifications. As shown in FIG. 2, logic gate 322 determines whether there are reminders required, at which point the delay 326 is employed prior to transmitting the reminder. Delay 326 is set on the profile input form under the notification preferences. In the exemplary input form 500 in FIG. 4, notifications are available at different intervals, of a set number of days prior to the auction, a set number of hours prior to the auction, or no reminders at all. In the exemplary input form 500 of FIG. 4, the user has selected box 536 to create a reminder to be transmitted 1 day prior to auction.

Now referring to FIG. 5, an alternative embodiment of the notification preferences 526 for an exemplary profile input form 500 is generally designated 600. Augmenting the notification preference 526 in FIG. 4, alert preferences 538 facilitates the user's selection of what desired information the notification alert includes. Here, the categories of relevant information selected are date and time of auction 540, auction house information 542 including street address 544 and website link 546. Other category types may also be selected including item of interest, lot number, individual auction name or number, auction house name and telephone number. It is to be appreciated the preceding list is merely exemplary of various types of information categories and other categories may be included.

While there have been shown what are presently considered to be preferred embodiments of the present invention, it will be apparent to those skilled in the art that various changes and modifications can be made herein without departing from the scope and spirit of the invention.

I claim:

1. An auction query and notification system comprising:
a server, comprising: a central processing unit (CPU); an auction database; a client database; and a means for contacting a plurality of users;
at least one auction agency having an inventory;
a plurality of users, each of said users having a user profile stored within said client database;
an information path between said server, said at least one auction agency and at least one of said plurality of users.

2. The auction query and notification system of claim 1, wherein said inventory of said at least one auction agency is accessible by said server via the Internet.

3. The auction query and notification system of claim 1, wherein said inventory of said at least one auction agency is manually updated within said auction database.

4. The auction query and notification system of claim 1, wherein said means for contacting said plurality of users is an email notification.

5. The auction query and notification system of claim 1, wherein said means for contacting said plurality of users is a text message.

6. The auction query and notification system of claim 1, wherein said means for contacting said plurality of users is an instant message.

7. The auction query and notification system of claim 1, wherein said means for contacting said plurality of users is via a wireless means.

8. The auction query and notification system of claim 1 wherein said user profile contains auction interest information.

9. The auction query and notification system of claim 1 wherein said user profile contains notification preferences.

10. The auction query and notification system of claim 9, wherein said notification system comprises a date and time of an auction, an auction agency street address, and an auction agency website link.

11. A method for auction query and notification, comprising the steps of:
creating a user account, having a user profile and a user notification profile
storing said user accounts in a user profile database;
accessing a plurality of auction agency data;
retrieving said auction agency data;
adding auction agency data to an auction database;
comparing said auction database to said user profiles;
displaying matches between said auction database and said user profiles on a user interface;
generating a user alert message in accordance with said user notification profile; and
transmitting said alert message to said user.

12. The method allowing auction query and notification of claim 11, wherein creating a user account further comprises the steps of:
inputting personal information;
creating a user interest profile;
selecting user interest criteria;
identifying specific artists of interest;
storing said user interest profile in user said profile database;
creating a user notification profile; and
storing said user notification profile in said user database.

13. The method allowing auction query and notification of claim 11, wherein said user interest profile comprises a date and time of an auction, an auction agency street address, and an auction agency website link.

14. The method allowing auction query and notification of claim 13, wherein said user interest profile further comprises an item of interest.

15. The method allowing auction query and notification of claim 13, wherein said user interest profile further comprises an artist of interest.
